(19) United States
(12) Patent Application Publication
(10) Pub. No.: US 2024/0427804 A1
(43) Pub. Date: Dec. 26, 2024

(54) SYSTEMS AND METHODS FOR MANAGING SHARDED DATA

(71) Applicant: MongoDB, Inc., New York, NY (US)

(72) Inventors: Andrew Michalski Schwerin, Providence, RI (US); Jason Carey, Austin, TX (US); Tyler Brock, Charlotte, NC (US); Garaudy Etienne, Brooklyn, NY (US); Jack Mulrow, New York, NY (US); Max Jacob Hirschhorn, New York, NY (US); Lamont Nelson, Brooklyn, NY (US); Kaloian Manassiev, Barcelona (ES); Geert Bosch, Brooklyn, NY (US); Randolph Tan, Astoria, NY (US); Jeff Yemin, Wayland, MA (US); Cory P. Mintz, Millstone Township, NJ (US); John Morales, Basking Ridge, NJ (US); Judah Schvimer, New York, NY (US)

(73) Assignee: MongoDB, Inc., New York, NY (US)

(21) Appl. No.: 18/748,846

(22) Filed: Jun. 20, 2024

Related U.S. Application Data
(60) Provisional application No. 63/509,518, filed on Jun. 21, 2023.

(51) Int. Cl. G06F 16/27; G06F 16/21

(52) U.S. Cl. CPC G06F 16/278; G06F 16/214

(57) ABSTRACT

A database system may comprise one or more nodes, where each node is embedded with functionality of each of a shard server configured for storing, retrieving, managing, and/or updating data; a shard routing process; and metadata management. A single node running these functionalities allows a database system to provide improved sharding functionality. Nodes may run on a same hardware profile. Database systems described herein may provide enhanced scalability and may appropriately scale without any input on the part of users.

### CROSS-REFERENCE TO RELATED APPLICATIONS

This application claims the benefit under 35 U.S.C. § 119 (e) of U.S. Provisional Application Ser. No. 63/509,518, filed Jun. 21, 2023, under Attorney Docket No. T2034.70078US00, and entitled “SYSTEMS AND METHODS FOR MANAGING SHARDED DATA,” which is hereby incorporated herein by reference in its entirety.

### COPYRIGHT NOTICE

At least a portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Database systems may be sharded with a database partitioned into different shards.

### SUMMARY

According to aspects of the disclosure, a database system may comprise one or more nodes, each embedded with shard server, shard routing, and configuration data functionality. For example, each respective node of the database system may be embedded with functionality of each of (1) a shard server that hosts one respective shard of data, of a set of shards of the data, stored across a set of nodes, and is configured for storing, retrieving, managing, and/or updating data of its respective shard; (2) a shard routing process such as a database router configured to accept requests for database access and route data operations based on configuration data; and (3) metadata management, such as by using a configuration server configured to maintain configuration data (e.g., routing metadata) across the set of shards. Each of these functionalities may executed both in a same virtual machine (VM) and in a same process. Accordingly, a single node running these functionalities allows a database system to provide improved sharding functionality, for example, because all nodes may run on a same hardware profile (e.g., for all instance sizes), and may therefore provide for enhanced scalability (e.g., allowing automatic scaling with reduced or no input from users).

According to aspects of the disclosure, there is provided a database system comprising one or more database partitions, the database system comprising at least one cloud-based resource, the at least one cloud-based resource including processor and memory a database subsystem executing on the at least one cloud-based resource, wherein the database subsystem comprises a first shard server configured to host a first database partition of the one or more database partitions, manage metadata associated with the one or more database partitions, and route database requests to the first database partition based on the metadata.

In some embodiments, the system comprises two or more shard servers, each shard server configured to host a respective database partition of the one or more database partitions, manage metadata associated with the one or more database partitions, route database requests to the respective database partition based on the metadata.

In some embodiments, each shard server is configured to run on a same hardware profile for all instance sizes.

In some embodiments, the database subsystem is configured to split the first database partition into the first database partition and a second database partition, wherein the database subsystem comprises further comprises a second shard server configured to host the second database partition, manage metadata associated with the one or more database partitions, and route database requests to the second database partition based on the metadata.

In some embodiments, the database subsystem is configured to split the first database partition into the first database partition and the second database partition automatically without user input.

In some embodiments, at a first time, the database subsystem comprises a single shard server.

In some embodiments, the database subsystem is further configured to migrate a database from a replica set topology to a sharded topology, the sharded topology including the first database partition hosted by the first shard server.

According to aspects of the disclosure, there is provided At least one non-transitory computer-readable storage medium having instructions encoded thereon that, when executed by at least one processor, cause the at least one processor to perform a method for hosting a database system comprising one or more database partitions, the method performed using a database system comprising at least one cloud-based resource comprising a database subsystem executing thereon, the method comprising using a first shard server of the database subsystem to host a first database partition of the one or more database partitions, manage metadata associated with the one or more database partitions, and route database requests to the first database partition based on the metadata.

In some embodiments, the database subsystem comprises two or more shard servers and the method further comprises using each shard server to host a respective database partition of the one or more database partitions, manage metadata associated with the one or more database partitions, and route database requests to the respective database partition based on the metadata.

In some embodiments, the method further comprises running each shard server on a same hardware profile for all instance sizes.

In some embodiments, the method further comprises splitting the first database partition into the first database partition and a second database partition, and the database subsystem comprises further comprises a second shard server and the method further comprises using the second shard server to host the second database partition, manage metadata associated with the one or more database partitions, and route database requests to the second database partition based on the metadata.

In some embodiments, the method comprises splitting the first database partition into the first database partition and the second database partition automatically without user input.

In some embodiments, at a first time, the database subsystem comprises a single shard server.

In some embodiments, the database subsystem is further configured to migrate a database from a replica set topology to a sharded topology, the sharded topology including the first database partition hosted by the first shard server.

According to aspects of the disclosure, there is provided a computer implemented method for hosting a database system comprising one or more database partitions, the method performed using a database system comprising at least one cloud-based resource comprising a database subsystem executing thereon, the method comprising using a first shard server of the database subsystem to host a first database partition of the one or more database partitions, manage metadata associated with the one or more database partitions, and route database requests to the first database partition based on the metadata.

In some embodiments, the database subsystem comprises two or more shard servers and the method further comprises using each shard server to host a respective database partition of the one or more database partitions, manage metadata associated with the one or more database partitions, and route database requests to the respective database partition based on the metadata.

In some embodiments, the method further comprises running each shard server on a same hardware profile for all instance sizes.

In some embodiments, the method further comprises splitting the first database partition into the first database partition and a second database partition, and the database subsystem comprises further comprises a second shard server and the method further comprises using the second shard server to host the second database partition, manage metadata associated with the one or more database partitions, and route database requests to the second database partition based on the metadata.

In some embodiments, the method comprises splitting the first database partition into the first database partition and the second database partition automatically without user input.

In some embodiments, at a first time, the database subsystem comprises a single shard server.

### BRIEF DESCRIPTION OF DRAWINGS

Various aspects of at least one example are discussed below with reference to the accompanying figures, which are not intended to be drawn to scale. The figures are included to provide an illustration and a further understanding of the various aspects and examples and are incorporated in and constitute a part of this specification but are not intended as a definition of the limits of a particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 illustrates a block diagram of an example distributed database system, according to aspects of the present disclosure;

FIG. 2 illustrates a block diagram of an example system architecture of a replica set according to aspects of the present invention;

FIG. 3 illustrates a block diagram of components of other example distributed database systems, according to aspects of the present disclosure;

FIG. 4 is an example block diagram of a special purpose computer system that can be configured to execute the functions discussed herein.

### DETAILED DESCRIPTION

According to aspects of the disclosure, a database system may comprise one or more nodes, where each node is embedded with functionality of each of (1) a shard server configured for storing, retrieving, managing, and/or updating data; (2) a shard routing process; and (3) metadata management. For example, database systems described herein may provide a mongod that performs functions of a shard server, and also a shard router and a config server. In doing so, such a mongod may be able to stand in for all three roles of a sharded cluster topology by routing and executing distributed requests as well as storing the metadata necessary to do so. Database systems may run the duties of the database router (e.g., a mongos), a primary or secondary shard server (e.g., a mongod), and the configuration server (e.g., a config server) on the same hardware profile for all instance sizes.

As described in more detail below, a database router such as a mongos may be configured to accept requests for database access, and route data operations based on the configuration data. A shard server such as a mondod may be configured to host one shard of data, of a set of shards of the data, stored across a set of nodes. A configuration server such as a config server may be configured to maintain configuration data (e.g., routing metadata) across a plurality of shards or other data arrangements.

In the present disclosure, functions of a mongod, a mongos, and the config server may all be performed by a same process. Various conventional implementation and conventional thinking separates these functionalities into distinct system to provide for improved distribution, computing power for each functionality, and aligns with the conventional thinking to segregates the respective so each can better serve its specialize role. Contrary to conventional implementation and thinking, merging these operations and/or invoking an emulation later enables the system to provide any one or more or combination of the following improvements: reduces startup complexity, reduces architecture roadblocks, simplifies upgrades tasks for existing architecture, among other options.

For example, providing a single node running the functionality of mongos, mongod, and config server allows a database system to provide improved sharding functionality. For example, database systems described herein may provide enhanced scalability. Because database systems may be set up with sharding as a default, as the usage of a user grows, the database system may be better suited to scale with the user's growth. Moreover, providing sharding as a default may enable the database system to scale without the user's input or knowledge, essentially making sharding invisible to the user. Certain users may desire that their database systems appropriately scale without any input on the part of the users.

Hardware parity between nodes may provide for enhanced scalability of database systems. In some embodiments, because all nodes may run on a same hardware profile, it many examples it is easier for the database system to spin up new nodes as usage of a user scales up, since each node may essentially be fungible.

In many conventional sharding systems, the architecture is complex enough that users may need to be product experts in order to appropriately scale their databases. Even still, such expert users may run into major issues. Users of conventional database systems may have trepidation around adopting sharding for a multitude of reasons such as complexity, lack of feature parity, degraded performance, unpredictable behavior, and difficulty reverting changes.

Database systems described herein provide a sharding system that simply works, and resolves may of the difficulties in conventional approaches. Various embodiments of the database systems described herein are configured to be consistent, performant, predictable, affordable, and without any data loss. Accordingly, database systems described herein make sharding invisible to the application are configured to provide automatic sharding. According to aspects of the disclosure, unsharded deployments may be completely or substantially eliminated. Database systems may shard for users automatically, without their knowledge by providing an experience that is both seamless and pleasant. Sharding users may not even notice that their database system is sharded.

In some embodiments, various users (On-prem, Atlas, Serverless) may start out with a sharded deployment. Collections in those clusters may be automatically partitioned as necessary, without work on the part of the cluster owner, and transparently to the application. Data placement and partitioning decisions may be made automatically, and overriding those decisions may be for optimization, rather than correctness concerns.

According to some aspects, sharding may be correct. Sharding may further function with no human effort, thinking, or involvement. For example, sharding may not require the high effort needed with conventional systems for determining the number of shards, choosing a primary shard, migrating chunks, etc. Applications using systems described herein may have to make very few (if any) changes to take advantage the system's sharding capabilities. In some embodiments, sharding may be fast. Users may see little to no difference between sharded and unsharded deployments, and between sharded and unsharded collections. In some embodiments, there may be little to no instances of data loss, corruption, or misplacement. In some embodiments, all or substantially all MongoDB features may be available in sharding. Sharding may provide acceptable performance, and sharding metrics/stats may be provided to users.

In some embodiments, a database system may perform resharding. Database systems may automatically recommend when to shard a collection, and may recommend which shard key to use. In some embodiments, there may only need to be user intervention when sharding or resharding a collection. In some embodiments, all collections may be sharded by default. Database systems may automatically scale clusters as necessary. Accordingly, users may not need to worry about what's happening behind the scenes.

Database systems described herein may provide sharding that is easy to use. For example, systems may employ a three-pronged approach: being able to reshard; figuring out which shard key to use, and acceptable performance after sharding. Furthermore, systems may abstract away the complexity of using a globally distributed database.

In some embodiments, there may be performance implications for single-shard clusters. Database systems may maintain a replica set emulation layer until customers no longer opt into replica sets. In some embodiments, sharded clusters may be the only option for new clusters created in certain versions of database systems, but systems may still give users an option to use the replica set emulation. By maintaining an emulation layer, database systems may maintain performance of replica sets.

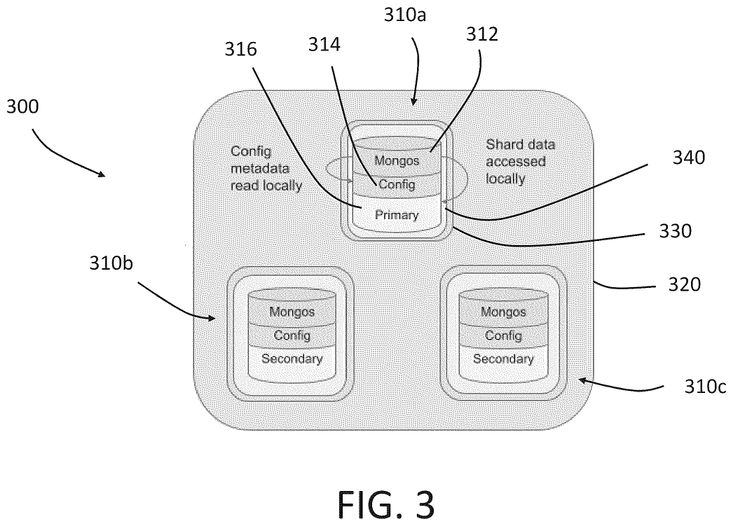

FIG. 3 shows a shard 300. Shard 300 may include similar components as shards of database system 100. However, shard 300 includes, at each node 310a, 310b, and 310c, a database router 312 (e.g., a mongos), a configuration server 314 (e.g., a config server), and a primary or secondary shard server 316 (e.g., a mondod). In the illustrative embodiment of FIG. 3, node 310a has a primary shard server 316 (and may be referred to as a primary node), while nodes 310b and 310c have a secondary shard server 316 (and may be referred to as secondary nodes). As shown in FIG. 3, each node 310a, 310b, and 310c has a same virtual private cloud (VPC) 320. In shard 300, the respective database router 312, configuration server 314, and shard server 316 of a node (e.g., node 310a) share both a same virtual machine (VM) 330, and a same process 340.

Shard 300 contrasts with some conventional shards, where configuration servers (e.g., config servers) may run in different VMs and different processes as shard servers (e.g., a mongod), and where each respective database router (e.g., a mongos) may run in a same VM as a shard server (e.g., a mongod) but in a different process.

In shard 300, the database router 312 (e.g., mongos) and the configuration server 314 (e.g., config server) may be embedded in the shard server (e.g., mondod). As such, the database router 312 (e.g., mongos) and the configuration server 314 (e.g., config server) run both in a same VM and a same process as the shard server 316 (e.g., mongod) as described above, allowing the database router to read config metadata locally from the configuration server and to access shard data locally from the shard server. Accordingly, a single node, such as node 310a, 310b, or 310c may perform every function that, in conventional systems, would be performed by a database router (e.g., mongos), configuration server (e.g., config server), and shard server (e.g., mongod). Functions of database router (such as a mongos), configuration servers (such as a config server), and shard servers (such as a mongod) are described in further detail below.

Aspects of the disclosure relate to replica sets and shards. Replica sets and shards are described in U.S. application Ser. No. 15/706,593, entitled “AGGREGATION FRAMEWORK SYSTEM ARCHITECTURE AND METHOD,” filed on Sep. 15, 2021, and incorporated herein in its entirety.

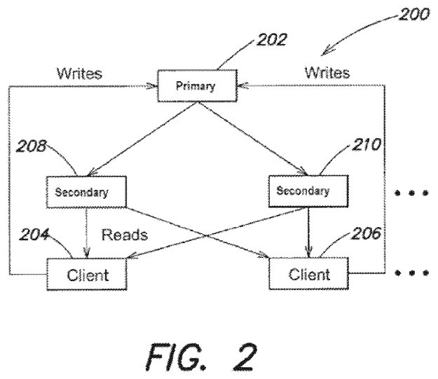

Replica sets can be implemented as a group of nodes that shares responsibility for a portion of data in a database (e.g., FIG. 2). In some embodiments, each replica set is configured to host one or more shards or partitions of data. application Ser. No. 13/078,104, entitled “SYSTEM AND METHOD FOR OPTIMIZING DATA MIGRATION IN A PARTITIONED DATABASE,” filed on Apr. 2, 2011 and incorporated herein in its entirety, discusses some embodiments of shared databases and/or shard clusters on which various aspects can be practiced.

Each partition can be implemented as one or more shards of data. Configuration servers can also be implemented to maintain configuration data across a plurality of shards and/or replica sets. The configuration data can reflect, for example, what data is stored in each of the shards. In some implementations, a database router can be configured to accept requests for database access, and route data operations based on the configuration data. Various database environments (e.g., router, config servers, and shard servers) can support various data architectures. In one embodiment, the base unit of data storage is configured as a document.

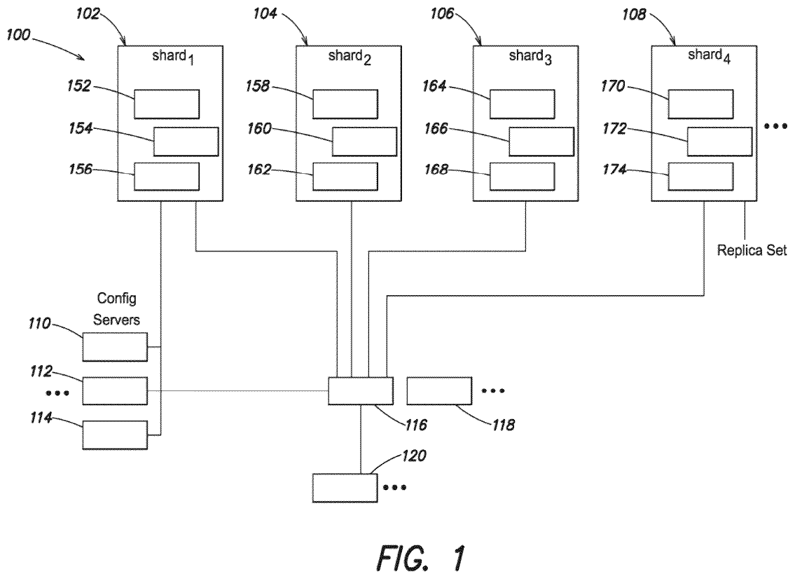

According to one environment of a database management system, one or more servers can host multiple shards of data, and each shard can be configured to respond to database requests as if the shard was a complete database. In one embodiment, a routing process can be employed to ensure the database requests are routed to the appropriate shard or shards. “Sharding” refers to the process of partitioning the database into partitions, which can be referred to as “shards.” FIG. 1 shows a block diagram of an example architecture for a database system 100, on which the aggregation framework can be implemented. The database system 100 has been specially configured as to provide access to stored data through database shards. The database can be hosted on a plurality of servers hosting a plurality of shards. The database system can be identified as a shard cluster, that is the grouping of shards that collectively represent the data within the database. A shard cluster typically comprises multiple shard servers (e.g., 102-108) hosting multiple partitions (e.g., 152-174) or shards of data, one or more configuration servers (e.g., 110-114) for metadata management, and shard router processes (e.g., 116-118) for directing data access requests, based on, for example, metadata on the configuration servers. Metadata for the shard cluster can include, for example, information on the ranges of data stored in each partition, information associated with managing the shard cluster, partition counts, number of shard servers, data index information, partition size constraints, data distribution thresholds, among other options.

Each shard of data (e.g., 152-174) can be configured to reside on one or more servers executing database operations for storing, retrieving, managing, and/or updating data. In some embodiments, a shard server 102 contains multiple partitions of data, which can also be referred to as “chunks” of database data. In some embodiments, a shard of data corresponds to a chunk of data. A chunk is also a reference to a partition of database data. A shard or chunk can be configured as a contiguous range of data from a particular collection in the database. Collections are logical organizations of subsets of database data. In one example, a collection is a named grouping of the data, for example, a named grouping of documents. As discussed above, documents can be as a base unit of storage of data the database. Some examples of document organization formats include the known JSON (JavaScript Object Notation) and BSON (binary encoded serialization of JSON) formatting for documents.

According to one embodiment, configurations within a shard cluster can be defined by metadata associated with the database referred to as shard metadata. Shard metadata can include information on collections within a given database, the number of collections, data associated with accessing the collections, database key properties for a given collection, ranges of key values associated with a given partition, shard, and/or chunk of data within a given collections, to provide some examples.

The three dots illustrated next to the system components, in FIG. 1, indicate that the system component can be repeated. In some embodiments, adding additional shards, configuration servers, and/or shard routing processes can increase the capacity of the database system. The shard router processes 116-118 handle incoming requests from clients 120 (e.g., applications, web services, user initiated requests, application protocol interfaces, etc.). The router processes 116-118 are configured to provide a transparent interface to handle database requests. In particular, client 120 need not know that a database request is being served by a sharded database. The shard router processes receive such client requests and route the database requests to the appropriate shard(s), e.g., 152-174 on shard servers 102-108.

According to some embodiments, a router process, e.g., 116, can be configured to operate as a routing and coordination process that makes the various components of the cluster look like a single system, for example, to client 120. In response to receiving a client request, the router process 116 routes the request to the appropriate shard or shards. In one embodiment, the router process (e.g., 116 or 118) is configured to identify aggregation operations, analyze the operations within an aggregation wrapper to determine what data is necessary for a given operation and route requests to the shards in which that data is stored.

The shard(s) return any results to the router process. The router process 116 can merge any results and communicate the merged result back to the client 120. In some examples, the router process 116 is also configured to establish current state information for the data distributed throughout the database by requesting metadata information on the database from the configuration server(s) 110-114. In one example, the request for metadata information can be executed on startup of a routing process. Further requests can be initiated by the routing process and/or can be initiated by a configuration server. In another example, a change at the configuration server can trigger a distribution of updates to any routing processes.

In some embodiments, any changes that occur on the configuration server(s) can be propagated to each router process 116-118, as needed. In one example, router processes 116-118 can be configured to poll the configuration servers(s) 110-114 to update their state information periodically. In others examples, router processes can be configured to poll the configuration servers(s) 110-114 to update their state information on a schedule, periodically, intermittently, and can be further configured to received updates pushed from the configuration server(s) 110-114 and/or any combination of thereof.

According to some further embodiments, router processes can run on any server within the database and/or on any number of server(s) that is desired. For example, the router processes can be executed on stand-alone systems, and in other examples, the router processes can be run on the shard servers themselves. In yet other examples, the router processes can be run on application servers associated with the database.

According to one embodiment, configuration server(s) 110-114 are configured to store and manage the database's metadata. In some examples, the metadata includes basic information on each shard in the shard cluster (including, for example, network communication information), server information, number of chunks of data, chunk version, number of shards of data, shard version, and other management information for routing processes, database management processes, chunk splitting processes, etc. According to some embodiments, shard or chunk information can be the primary data stored by the configuration server(s) 110-116. In some examples, shard and/or chunks are defined by a triple (collection, minKey, and maxKey) and the metadata stored on the configuration servers establishes the relevant values for a given chunk of data.

In some embodiments, a shard cluster also includes processes for automatic failover and/or recovery. Proper operation of a shard cluster can require that each shard always remain online, or from a more practical standpoint, as available as is reasonably possible. Inconsistent results can be returned if one of the shards hosting necessary data is unavailable. According to one embodiment, each shard server in a shard cluster can be implemented as a replica set, e.g., shard server 108. A replica set can be configured to perform asynchronous replication across a series of nodes, with various processes implemented to handle recovery of primary node operations within the replica set. Such a configuration insures high availability of the data replicated throughout the replica set.

Aspects of the disclosure relate to daemon processes. Daemon processes are described in U.S. application Ser. No. 15/721,176, entitled “LARGE DISTRIBUTED DATABASE CLUSTERING SYSTEMS AND METHODS,” filed on Sep. 29, 2017, and incorporated herein in its entirety. Each shard of data can be configured to reside on one or more servers executing database operations for storing, retrieving, managing, and/or updating data. According to one embodiment, the operations for storing, retrieving, managing, and/or updating data can be handled by a daemon process executing on the server(s) hosting the shard. Where the shard server(s) are implemented as replica sets, each replica set is responsible for a portion of a collection. The router processes send client data request to the right replica set based on configuration metadata (e.g., hosted by configuration servers/processes). In some embodiments, the router processes can be configured to communicate only with the primary node of each replica set (e.g., this can be a default configuration), and if the replica set elects a new primary, the router processes are configured to communicate with the newly elected primary. In one example environment, a client and/or client application can connect to the routing processes, which connects to a daemon process executing on a replica set hosting the respective shard of data containing requested or targeted data. The daemon process can be configured to handle query execution (e.g., reads at the primary only, reads at primary and secondary nodes, reads and writes at the primary only) and return requested data.

In one embodiment, a database system can be configured to permit read operations from any node in response to requests from clients. For reads, scalability becomes a function of adding nodes (e.g. servers) and database instances. Within the set of nodes, at least one node is configured as a primary server. A primary server/node provides the system with a writable copy of the database. In one implementation, only a primary node is configured to permit write operations to its database in response to client requests. The primary node processes write requests against its database and replicates the operation/transaction asynchronously throughout the system to connected secondary nodes.

In another example, the group of nodes, primary and secondary nodes operate in conjunction to process and replicate database operations. This group of nodes can be thought of a logical unit, a replica set, for handling database operations. Shown, for example, in FIG. 2 are the basic elements of a replica set, a primary or master node 202 and secondary or slave nodes 208-210. The primary node's responsibility can transition between nodes 202, 208, and 210 within the replica set, permitting operation even in light of failures within the replica set. The secondary nodes 208-210 host replicas of the primary database and are configured to take on the primary role automatically in the event of a failure.

In another example, the primary node receives and performs client writes operations and generates an operation log. Each logged operation is replayed by the secondary nodes bringing the replicated databases into synchronization. In some embodiments, the secondary nodes query the primary node to identify operations that need to be replicated. The replica set and/or individual nodes can be configured to response to read request from clients by directing read request to slave nodes 208-210.

Clients, for example 204-206, from the perspective of a distributed database can include any entity requesting database services. A client can include an end-user system requesting database access and/or a connection to the database. An end-user system can request database services through an intermediary, for example an application protocol interface (API). The client can include the API and/or its associated drivers. Additionally, web based services can interact with a distributed database, and the web based services can be a client for the distributed database.

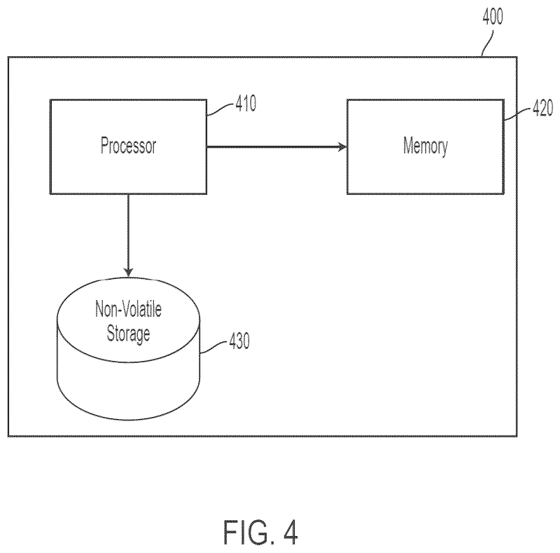

By implementing each shard as a replica set, the shard cluster can provide for high availability and high consistency in the underlying data. In one example, a replica set can be a set of n servers, frequently three or more, each of which contains a replica of the entire data set for the given shard. One of the n servers in a replica set will always be a primary node. If the primary node replica fails, the remaining replicas are configured to automatically elect a new primary node. Each illustrated server can be implemented as a replica set, for example, as discussed in application Ser. No. 12/977,563 entitled “METHOD AND APPARATUS FOR MAINTAINING REPLICA SETS” filed on Dec. 23, 2010, incorporated herein by reference in its entirety. Other replication methodologies can be used to insure each shard remains available to respond to database requests. In some examples, other multi-node systems can be used to provide redundancy within a sharded database. In one example, master/slave configurations can be employed. In others, various distributed architectures can be used for each shard within the shard cluster. In some embodiments, each replica set can also execute an aggregation engine for receiving aggregation operations. Further, the aggregation engine can further optimize operations within an aggregation operation locally. In some embodiments, an aggregation engine associated with a routing process can identify the potential for local optimizations, and pass the aggregation operation to another aggregation engine being executed locally on a replica set hosting data needed to complete the aggregation operation. Further dependency analysis can be executed locally as well as re-ordering of execution of operations within the aggregation operation. An illustrative implementation of a computer system 400 that may be used in connection with any of the embodiments of the disclosure provided herein is shown in FIG. 4. The computer system 400 may include one or more processors 410 and one or more articles of manufacture that comprise non-transitory computer-readable storage media (e.g., memory 420 and one or more non-volatile storage media 430). The processor 410 may control writing data to and reading data from the memory 420 and the non-volatile storage device 430 in any suitable manner. To perform any of the functionality described herein, the processor 410 may execute one or more processor-executable instructions stored in one or more non-transitory computer-readable storage media (e.g., the memory 420), which may serve as non-transitory computer-readable storage media storing processor-executable instructions for execution by the processor 410.

An exemplary architecture for invisible sharding is provided. Some aspects relate to sharding development. For example, a high-level overview of an architecture of “Sharding Only Development” is provided. The architecture described here may be implemented by projects in the invisible sharding initiative.

Architecture aspects include a “sharding only” development with MongoDB features developed that present a unified product offering that may always consider the sharded use case. In some embodiments, a Single Node Cluster may be a single mongod node that is a sharded cluster. A a Mongos may be a binary that provides only the cluster routing role. An Embedded Mongos may be a router role executing within a mongod process. A Router may be a Mongos or Embedded Mongos. An External Connection may be a connection that is not an internal connection. An Internal Connection may be a connection that originate from MongoDB topology components. A Config-Shard may be a Mongod node that provides both config server and shard server functionality. A Sharded Handshake may be a handshake response that indicates a driver is connected to a sharded cluster (e.g., {“isdbgrid”: true}). A Replica Set Handshake may be a handshake response that indicates a driver is connected to a replica set (e.g., {“setName”: <setName>, hosts: [<host> . . . ]}). A Sharded Interface may be a set of commands which can be run on a router and their response shape. A Replica Set Interface may be a set of commands which can be run on a replica set and their response shape. System Data may be data in admin, config, or local databases. User Data may be data other than the system data.

An architecture summary is provided. According to a first aspect, embedded sharded topology components are described. In order to migrate users from the replica set topology to the sharded topology, systems may comprise a MongoDB sharded topology with components that are available without: increasing the cost of the cluster compared to a replica set; or increasing the operational complexity of the cluster compared to a replica set.

Systems may provide the above by providing a mongod that acts as both a router and a config server, in addition to a shard server. In doing so, mongod may be able to stand in for all three roles of a sharded cluster topology by routing and executing distributed requests as well as storing the metadata necessary to do so.

Config server functionality is provided. The shardsvr and configsvr cluster roles may no longer be mutually exclusive. Mongod nodes may serve as “config-shards”, providing both config server and shard server functionality. Config-shards may not expose an additional port for config server functionality and may serve both user data and cluster metadata over the already exposed mongod port. When started in this mode, the default mongod port may remain the default mongod shardsvr port (27018). The port used by mongod can be reconfigured via the -port command line argument. Cluster operators who may like to isolate the impact of user workloads on their cluster health or who may like to scale config servers independently of their shards can continue to run dedicated config server replica set (CSRS) processes. Cluster operators may be able to migrate between colocating cluster metadata with user data on config-shards or running dedicated config servers with zero downtime.

Router functionality is provided. The router role may no longer be exclusive to mongos. Mongod may be able to be started with the router role by supplying the -router command line argument. Before MongoDB 8.0, the router role may be available but may be disabled by default. After 8.0, the router role may be permanently enabled. A mongod in the router role may default to accessing cluster metadata locally via its embedded config server (as a config-shard). If a mongod node is started in the router role but is not a config-shard, the user may be required to provide a -configdb connection string argument referencing a CSRS. The router role may be enhanced to support replica set management commands. On clusters with a single shard, invoking a replica set management command against the routing layer may forward those commands to the underlying replica set for the implied shard. In the case where a cluster has multiple shards, commands may require an additional shard identifying argument that specifies to which shard's replica set the command should be routed. For larger clusters that may want to scale mongos independently of mongod, cluster operators can run dedicated mongos processes and transition between the two topologies seamlessly.

Router functionality may be exposed. Systems may expose mongod's router functionality and may make it available simultaneously conventional replica set functionality. In some embodiments, users may automatically switch to the sharded interface so that they can take advantage of features built for sharding. In some embodiments, mongod may not behave like a mongos. Conventional application servers connected to what they believe is a replica set may continue connecting to an endpoint that responds like a replica set. Additionally, unsharded collections accessed via a mongos may behave differently when accessed by connecting directly to a replica set. As a result, exposing both handshakes and interfaces at the same time may be necessary so users can upgrade MongoDB without changing anything and then ultimately migrate to the sharded interface without downtime. The following subsections describe how systems may make router functionality available: via ports, via SNI, and via clients explicitly requesting the desired interface in the connection handshake.

In some embodiments, router functionality may be exposed in development (ports). When mongod is in the router role, systems may either open a new port or override the existing mongod port behavior to expose the router functionality. Connecting to this port may provide the sharded handshake. Internal cluster connections (between existing replica set members) can continue to use the mongod port and receive the replica set handshake so that intra-cluster communication can continue without requiring new ports be opened in a firewall. The port used by the routing layer can be reconfigured via the -routerPort command line argument. Shards may be able to internally route requests to service user operations using the routing layer even if those requests come from inside the cluster (like another shard).

Router functionality may be exposed on Atlas (SNI). On Atlas, systems may leverage SNI in order to expose the mongos functionality. By making the mongos interface available on a new hostname, Atlas can seamlessly upgrade MongoDB binaries without asking users to change their connection strings (and restart their app) or open new ports in their firewall. This approach may also enable the transition of users to sharding functionality over time without requiring them to reconfigure their cloud infrastructure. For example, Atlas tenant's SRV connection string begins resolving to same port but a different host:
mongo+srv://tenant.mdb.net->unsharded.tenant.mdb.net: 27017->Replica Set
mongo+srv://tenant.mdb.net->sharded.tenant.mdb.net: 27017->Sharded

To enable this functionality, mongod may accept a-routerHosts [<FQDNs> . . . ] command line argument that may allow MongoDB cluster operators to specify what hostnames should return the sharded handshake. When -routerHosts are specified, mongod may respond to external connections over the mongod port with the sharded handshake for the mongos hostname and provide the replica set handshake otherwise. The -routerHosts functionality may be undocumented in order to discourage use by non-atlas cluster operators. Systems may not intend for this functionality to be used outside of Atlas.

Engineering aspects include that shards can provide config server functionality and that shards can provide mongos functionality.

Product aspects include that on Atlas, choosing a 1-shard cluster may be a more compelling choice than before, there may be no additional cost for running a sharded cluster, on Atlas, a single shard cluster can become the default configuration for new clusters, and Atlas users can opt-in to creating a new replica set.

Aspects relate to interface parity for unsharded collections. To make migrating to the sharded interface as seamless as possible, systems may have reduced discrepancies between a replica set interface and a sharded interface, which may make them indistinguishable to applications from one another post handshake. Systems may make unsharded collections and databases that are accessed through mongos behave similarly to how they operate when accessed as a replica set, which may not be related to how sharded collections operate.

Engineering aspects may include differences between the mongos/replica set interfaces and differences to converge on a unified interface for unsharded collections.

Product aspects may include that conventional replica set users may migrate to sharded cluster with reduced friction and lower risk, and on Atlas, sharded clusters may become the only configuration for new clusters.

Aspects relate to a replica set emulation layer. Systems may provide for all database requests to be serviced through sharding code paths. Systems may not control when existing users may restart their applications (resolving a new SRV record) or migrate their applications to a sharded connection string. If users delay modifying their connection string (potentially by not restarting their app) they may continue to bypass the sharding code paths and prevent systems from achieving sharding only development. As a solution to that problem, systems may make it so the embedded router role can emulate the handshake and operational commands current MongoDB drivers may expect from a replica set. By doing so, systems may allow connecting and sending requests to emulated replica set endpoints that engage the sharding code paths.

The solution provides two advantages: it allows systems to accelerate the timeline for sharding-only development (8.0 vs later), and it allows systems to avoid asking users to restart their applications (in some embodiments, forever).

In order to provide those advantages, systems may provide a Replica Set emulation layer that may: return underlying replica set node information to drivers during the connection handshake, authenticate and manage users with cluster-wide credentials, and send all queries, mutations, and commands through the mongos routing+execution code paths.

In some embodiments, drivers can continue to connect and send requests to what they believe is a replica set without changing their connection string or restarting their application. All database requests may be serviced through the MongoDB sharded topology layers and systems may deprecate users connecting directly to replica sets. Additionally, many replica set users whose applications depend on low latency operations may not tolerate an additional availability zone hop to service requests until they may need horizontal scalability. By emulating the replica set handshake behavior for single-shard clusters, MongoDB drivers may continue to offer low-latency write requests that directly target the appropriate node for the operation. These features allow systems to protect the integrity of the cluster by disallowing direct connections to the shards except through mongos.

Aspects relate to interaction with sharding features. The emulation layer may not allow access to sharded collections or unsharded collections in databases where the primary has been moved. The emulation layer may not be available on mongos.

Engineering aspects may include that embedded mongos can emulate the replica set handshake and that all user requests may be serviced through mongos code paths.

Product aspects may include that existing users can continue to connect to a “replica set” and that new features can be created “sharding-only”

In some embodiments, all clusters may start as one shard clusters (8.0). Systems may include features that are “sharding-only” and systems may ensure users can get started quickly and use MongoDB's full set of capabilities. Atlas or OpsManager can bootstrap a sharded cluster automatically and make it ready for use at the click of a button. For unmanaged on-premise and community deployments of MongoDB there may still be several manual steps (initiating the replica set, adding the shards) in order to get started with a one-shard cluster. Where systems may make it too difficult for users to get started, they may eschew new features or decide to not use MongoDB. One aspect of systems is for mongod to bootstrap itself in to expose the sharded interface by default and, when the user connects, to have a fully functional cluster ready for use. Any existing standalone or replica-set deployment may automatically become a single shard cluster upon FCV upgrade.

In some embodiments, in FCV 8.0: standalone nodes may become single node clusters, replica sets may become single shard clusters, nodes serve in all three roles of sharded cluster topology, members of previously sharded clusters may operate as usual, mongos stay mongos (different binary), config server replica sets continue to hold no user data, and shard servers stay shard servers.

In some embodiments, systems may use one or more of the following options: ship mongod as wrapper script that takes all the appropriate actions on behalf of the user to bootstrap and expose a functioning cluster, have mongod bootstrap itself appropriately by having new nodes determine whether they should join or create a cluster (described in detail here), or ship a new binary (such as mongoc) that may behave like a mongod with the ability to self-bootstrap (and leave mongod alone).

Engineering aspects may include single mongod nodes bootstrap themselves as a sharded clusters.

Product aspects may include sharding-only development may be achieved where non-atlas users also start with a sharded cluster.

Architecture details are provided. Some aspects relate to cluster self-bootstrapping. In version 8.0 of MongoDB systems may provide that new sharded clusters can be created and existing clusters can be expanded by running new instances of mongod without any required command line arguments. With these features, large clusters (having hundreds of nodes) may be started generically and configured programmatically which allows operators to treat MongoDB instances more like cattle and less like pets. Additionally, all existing deployments may be automatically converted to sharded clusters.

In some embodiments, systems may be configured such that: the -router flag (router role) may be always enabled and may not be able to be disabled, the -replSet argument may become an implicitly provided (enabled) argument, the -shardsvr, -configsvr flags (and roles) may default to being enabled, or if any one of them is specified individually then they default to being disabled in order to let users selectively designate a mongod as a dedicated shard server or a dedicated config server replica set member.

The router role being permanently enabled means that systems can take advantage of the router role functionality but systems may initialize the cluster before it can be used. The replica set functionality being enabled may mean that users may have an unusable cluster until systems initialize the replica set. The shardsvr+configsvr roles allow systems to store cluster metadata locally but may not require that. When combined, mongod having the router role, shard server role, config server role, and replication enabled by default means systems may have everything used to initialize a replica set and bootstrap a sharded cluster automatically.

Aspects relate to bootstrapping new clusters. In order for new mongod nodes to determine whether they should start a new cluster or join an existing one, they may wait to receive a request. If the cluster receives a request to read or write user data it may automatically become a replica set+sharded cluster (a.k.a. “single node cluster”). After initializing the replica set, the mongos may then establish that new set as the first shard. At this point, systems may have a fully functional sharded cluster that can service the inbound request and return a response to the user. Upon subsequent starts of the bootstrapped node, mongod may be able to introspect its state as a replica set member and member of a sharded cluster in order to resume normal operation and service user requests. In the case of a single node cluster, the bootstrap process may be driven by the embedded router role. In the case where the router role is provided by mongos, the mongos node that received the request may bootstrap the cluster.

Aspects relate to growing clusters. When a mongod node is started for the first time it can alternatively receive a request that indicates it should join an existing cluster. An example of this may be someone attempting to add an additional replica set member for higher availability or adding an entirely new shard to expand cluster throughput.

Aspects relate to growing clusters and adding replica set members. In this situation, a user may start a new mongod node which may wait to receive a request. The user may then connect to an already available node in the router role and run a replica set management command to add the new node as a member of the replica set. Executing the command may reconfigure the shard's replica set and send a request for the new node to join the set and become part of the cluster.

Aspects relate to growing clusters and adding shards. Another example of growing a cluster may be someone attempting to add an additional shard to increase cluster throughput. In this situation, a user may again start a new mongod node (or multiple mongod nodes) that may wait to receive a request. The user may then connect to an available node in the router role on the existing shard and run the command to add a shard providing a replica set connection string specifying both the set name as well as the host and port of the new member(s). The command may then send a request to the new nodes indicating they should bootstrap themselves as a new replica set with the specified set name and subsequently form a new shard for the existing cluster. The process waits for the set to initialize all the provided members. When set initialization is complete the newly formed replica set is added as a shard to the cluster. A user may add multiple additional nodes that form a replica set for the new shard by specifying them all as part of the replica set connection string argument to the addShard command.

Aspects relate to upgrading existing clusters (e.g., from 7.x). Upgraded mongod nodes are able to determine whether they are already part of a replica set and rejoin the set on startup as well as examine their shard identity to see whether they already are members of a sharded cluster and act accordingly. All nodes can be upgraded in a rolling fashion with the cluster online and without application restarts. Cluster bootstrapping may take place upon FCV upgrade.

In some embodiments there may be a process to upgrade three node replica set with little or zero downtime to (e.g., upgrade to 8.0): (1) stop secondary node+upgrade binary+bring it back up, (2) repeat step 1 with the other secondary node(s), (3) step down the primary node, (4) repeat step 1 with the original primary node, (5) run FCV upgrade.

Additional considerations relate to maintenance modes. Running MongoDB without any arguments may now start replication and sharding topology components by default. Systems may provide a way for the server to perform tasks like start and take writes but not have those writes enter the oplog as well as a way to remove a shard from a cluster but keep replication operational for maintenance purposes.

In some embodiments, use cases include: rolling index builds (to build the index but not have create index command enter oplog), cloud restore (cloud automation may mangle node metadata without changes entering oplog), a manual recovery that involves modifying data on nodes one by one (like renaming a replica set), point-in-time restore brings up a CSRS as a replica set, or QueryableWiredTiger flag—in this mode systems may query datafiles remotely

Systems may provide this functionality by having a command line parameter to temporarily enter maintenance modes-maintenanceMode=standalone|replicaSet. In some embodiments, replicaSet maintenance mode may not be used long term or may be used for point in time recovery.

A connection string that includes the replicaSet parameter may not connect to a mongos in some embodiments. Some applications that are connected to replica sets may fail if systems respond to connection requests with the mongos handshake because MongoDB drivers check to see if responses to the hello command indicate connection to the specified replica set.

A connection string of mongodb://host?replSet=tyler with a handshake response of Replica Set may correspond to a driver connection result of connects. A connection string of mongodb://host?replSet=tyler with a handshake response of Mongos {“isdbgrid”: true} may correspond to a driver connection result of fails to connect.

The server may not tell if the user is requesting the replica set interface or the sharded interface via the parameters provided in the connection string. The driver may not send the replicaSet param as part of the handshake's hello request so systems may have no way of knowing whether existing drivers intend to connect to a replica set or a sharded cluster.

Systems may not emulate replica set behavior in mongos. The emulated replica set behavior may be only available on mongod.

Systems may not provide the emulated replica set interface on all shards in a multi shard cluster. Just on the first shard.

Aspects relate to how far the replica set emulation layer goes. It does not return data from sharded collections. It does not return data from unsharded collections on other shards (movePrimary was run). Users may not run sharding management commands like addShard through the emulation layer.

Aspects relate to a workaround for users who depend on low latency writes via SDAM in drivers. Because systems may emulate replica set handshake behavior, MongoDB drivers can offer low-latency writes by directly targeting the primary node and low latency reads by directly targeting secondary nodes (for “secondary” read preference) on single-shard clusters.

Aspects relate to the configsvr bool flag in the replica set configuration. Systems may store it as “true” for the first replica set that gets initiated in the cluster when-configdb is not provided. Otherwise it may be unset.

Not all collections may be sharded in some embodiments. All collections being sharded may happen in other embodiments.

Aspects relate to capped collections. Capped collections may be still allowed in sharded clusters. They may always be unsharded collections.

Aspects relate to standalone conversion. The user may stop the old binary and start the new one. On FCV upgrade their connection may drop and reconnect. When they reconnect they may receive the sharded handshake.

The router role may use a new port rather than taking over the mongod port. Systems may prioritize minimizing effort for existing users to use sharding-only features because they may have a higher downside risk of not being able to access their application if they don't get something right (like configuring the new version of mongod correctly to support the previous behavior).

Users who access the oplog directly may be impacted. As systems move toward a configuration world where all cluster access is mediated through mongos users currently leveraging oplog access may change their application to leverage change streams rather than interacting with the oplog directly. Another alternative is support for querying the oplog through the emulation layer, where users may continue building on top of implementation details that may change vs change streams which have a more stable API.

The -serverless flag may interact with implicitly enabled replication (in some systems, they are mutually exclusive). Systems may take two paths for that functionality: Where-replSet is implicit specifying-serverless may override that to enable it's flavor of replication. Systems may make the flags converge.

When exposing the router role on mongod, a new port may be used or other mongod port behavior may be overridden. For example, it may be exposed it via 27017 (existing port) or a new port (27016 for example). An advantage of taking over the mongod port is that all existing documentation and drivers that default to connecting to a mongod node on 27017 may result in users receiving the sharded interface by default. When the router role is enabled this effectively starts all new users with the sharded interface. A disadvantage of taking over the mongod port is that the router role has taken over the external handshake of the mongod port. Existing applications with replica set connection strings may modify those connection strings and restart in order to continue connecting. To get around that, users may need to provide additional configuration by specifying the -routerPort command line argument if they'd like to have the router role be exposed on a distinct port. In some examples, the system can automate or build command line prompts for the user and ask them to enabled. Systems may minimize effort for existing users to upgrade so systems can achieve sharding-only development because they have a higher downside risk if they don't get something right while upgrading. Systems may take a different approach depending on whether data files exist or not on upgrade (exposing it via 27017 if it's a fresh cluster/new user and on another port otherwise). Systems may treat someone trying mongodb on their local machine vs manually managing their cluster separately.

Alternative to exposing mongos, systems may have the drivers build an explicit handshake (cluster type may not be something that systems expose in the client UX, with “invisible sharding” where users may be able to stop thinking about this difference). In one embodiment, drivers may start sending information about the connection string replSet param in the handshake. In this embodiment, systems may keep user UX the same, and may send the expected connection type as part of {hello}-which may give systems an easy way to see which users folks take advantage of the emulation layer on 8.0+ and nudge users to change (like when they want to add more shards warn them, among other considerations). In another embodiment, systems may provide a set of drivers that can override the default interface they receive by explicitly requesting the one that is to be used. With these drivers, a mongod or mongos node may be able to respond to a replica set handshake when an application explicitly requests it and provide the mongos interface otherwise when the router role is enabled. For example, user specifies: mongodb+srv://garaudy.monogdb.net?interface=replSet/interface=mongos; Driver sends: {hello: 1, interface: mongos. Where the emulation layer is removed, the behavior of {hello: 1, replicaSet: “rs1”} may be one of: ignore replicaSet parameter and present as a router (in which case the driver may refuse to connect given the existing semantics of the parameter), reply with error (and reject all future commands on the connection), close the connection, the first may essentially revert to the conventional behavior of a mongos.

Where systems expose the router role over the mongod port and provide a way to determine if the inbound connection is internal or external, the “isInternalClient” metadata may or may not be secure and guaranteed to be correct, or an authorization system may be used for determining internal vs. external clients. In some embodiments, the metadata may not be secure and guaranteed to be correct. The hello command, which may not require auth, sets this value if a specific argument is provided. There may not be validation to ensure that only a peer node is setting this argument. Systems may not leverage this except where exposing the router role over the mongod port.

Quarterly upgrade customers may not make necessary application changes. The emulation layer may allow their application to continue running without changes.

Aspects relate to backup and restore. Aspects relate to the automated restores process moved into the server. It may change the process in the MongoDB Agent in Cloud during restores. Systems may bring processes up as standalones on ephemeral ports.

Systems may relate to a replica set maintenance mode (sharding disabled but replication enabled). Systems may provide “point in time” (PITR) restores. As server takes over ownership of the recovery procedure for restores, this mode may not be used. For PITR, the automated restore process may require that systems bring up CSRS members as single-node replica sets before running apply ops. This means that systems may bring up the process on an ephemeral port, but without changing its replication fields. For other purposes, systems may bring processes (including config servers) as standalones, by restarting them without their replication fields.

Systems may provide an operations experience that is pleasant with seamless scaling for any workload. Systems may abstract away the complexity of using a globally distributed database. Systems may improve customers scaling experience by enabling MongoDB to work well for the most demanding workloads. Aspects relate to running MongoDB in Atlas casier and more resilient. Systems provide increased speed, agility, cost-effectiveness, and quality of SDLC.

Aspects relate to system performance. Performance (from an application's viewpoint) may be addressed in some embodiments. In a replica set, a write may go directly to the primary. With a single-shard cluster, it can go to a mongos that's colocated with a secondary in a different data center, which then gets routed to the primary. The replica set behavior may not be supported by sharding's architecture. As a result, performance may be different in some embodiments. System may have the performance implications of single-shard clusters and maintain the replica set emulation layer until customers no longer opt into replica sets. Sharded clusters may be the only option for new clusters created on 8.0 onwards, but systems may still give customers an option to use the replica set emulation connection string if they are concerned about single-thread latency. By maintaining the emulation layer, systems may have the same performance as today's replica sets.

Product aspects may include that: sharding may be a default option for newly created 7.2 and above clusters, if an Atlas user wants a replica set (for low latency), they may be automatically placed on top of a replica set emulation layer, any Atlas cluster that upgrades to 7.2 or newer may be automatically converted to the emulation layer, switching an existing replica set to a sharded cluster may be 100% online, an old driver can continue to connect to a “replica set” forever—with a connection string pointing to the mongod ports, an application with an old driver that is API version 1 compliant may not require making any changes to their application to connect to MongoDB 9.0, users may needs to be able to upgrade through 7.0, 8.0, 9.0 without restarting their app, users connecting directly to their mongod may not be able to use some features, users with private endpoints may not be able to leverage features without extra work, systems may run the duties of mongos, mongod, and collocated config server on the same hardware profile for all instance sizes, duties of a mongod and a mongos and the config server may all be performed by a same process, and intra-cluster communication may continue to use only the original mongod ports. (For example, all ports other than the original mongod ports may be blocked in an on-prem environment and that on-prem customers cannot get new ports opened.)

In some embodiments, unsharded replica sets may be removed and all MongoDB clusters may be started as one-shard clusters. This may simplify and accelerate server feature development. Users may get sharded features faster and no longer have to deal with the knowledge of replica sets and sharded clusters. MongoDB may be easier to use as there is less confusion around which feature is available in which deployment model.

A key differentiator for MongoDB to conventional systems is native sharding. Native sharding allows cost-effective scale-out and precise control over where data is physically stored within a distributed cluster. Combined with the ability to change the shard key at any time, no other database, whether relational or NoSQL, provides the versatility or flexibility of MongoDB in addressing the broadest set of application use cases.

MongoDB's new capabilities are often created for non-sharded deployments, with sharding support coming months or sometimes years later. This combination of temporary and permanent feature gaps between non-sharded and sharded deployments often leads to user confusion and disappointment. In addition, it increases the burden on our user-facing teams since they have to keep track of which features exist on which deployment model. In addition, they must also be able to explain the reasoning behind such experience gaps and when those gaps will disappear.

The existence of replica sets and the operational complexities around transitioning to sharded clusters encourage customers to put off thinking about sharding. This often leads to suboptimal decisions when it's time to shard a collection.

Lastly, sharded features tend to take even longer when it's time to deliver them. Sometimes it is because engineering teams did not design the new capability with sharding in mind and need to re-architect the entire feature to support sharding. Other times it is because additional testing is needed.

Aspects of the disclosure are beneficial to users, user-facing teams, along with engineering. User benefits may include that users get sharded features faster, there may be no more non-sharded/sharded differences for new features, systems eliminate the challenges around switching from a replica set to a sharded cluster, systems provide more resilient clusters by potentially putting every Atlas cluster behind mongoses with or without an L4 Load balancer

User considerations may include that sharding customers may not necessarily get a better sharded-collection experience, some features/commands may not currently work with mongos, and single-shard operation latency may be potentially worse than that of replica sets

Engineering benefits include that engineers only have to develop one production deployment, new features and feature spikes may only be built against sharded clusters, fewer sharding bugs, reduced cognitive load during development as engineers may not need to think about or design for two different deployment models, no new feature disparities between replica sets and sharded clusters, engineers can deliver sharded features faster, no need to write code twice (once for mongod and once for mongos), no redundant coordination between engineering teams across Atlas, Search, Server, etc due to the existence of two disparate environments, reduce the amount of testing necessary for new features, and systems may retire most of the drivers' code for SDAM.

Engineering considerations include changes for server features that don't work against mongos, major architectural changes from Cloud, a new backup procedure for both snapshot restores and PITR, intel IA enhanced for a new topology, Atlas automation to manage 1 shard clusters, architectural changes from Drivers (e.g., Drivers may not support seamless upgrades from replica sets to sharded clusters).

User-facing teams benefits may include for new features, may no longer have to keep track of what's in sharding vs just replica sets, and when the disparity will be gone, no more (potential) incorrect messaging to users about what's supported in sharding, may not have to pitch sharding as a new feature, removing sales friction, may not have to explain the concept of a config server until much later.

Use cases and target uses may include all 7.2+clusters.

Throughput, CPU headroom, and single-shard operation latency may be potentially worse than that of replica sets. Self-managed customers who need replica set latency may not be able to connect the emulation layer. Atlas customers can still select a replica set. It may not be easily discovered in order to encourage sharding as the default. Running the same tests for user-facing features between replica sets and one-shard clusters while Drivers do. There may be impact on migrations from on-prem into Atlas, effects on change streams, behavior of./mongod. Single-shard cluster or a standalone, and a percentage of Atlas users may use SRV records.

Aspects relate to providing “Sharding Only Development” such that new MongoDB features can be developed once and present a unified product offering that always considers the sharded use case. In some embodiments, all new clusters may start out as 1-shard clusters & all existing RS clusters and standalones may convert to 1 shard clusters (e.g., in 8.0)

Cloud aspects are also provided, such as support for in cloud products. For example, Some aspects relate to Atlas. In Dedicated, there may be concurrent support for all new MongoDB 8.0 clusters may be sharded clusters, with choice between dedicated and embedded config servers may be made by the Atlas system and all mongos may be embedded. All existing sharded clusters that are upgraded to MongoDB 8.0 may be transitioned to embedded mongos. Atlas system may determine whether or not to transition to embedded config servers. All existing replica sets that are upgraded to MongoDB 8.0 may become sharded clusters with embedded config servers and embedded mongos (may include Free/Shared Tiers such as M0/M2/M5, as multiple improvements to connection management that may be included in free tier). MongoDB 8.0 may include a replica set emulation layer that drivers can continue to connect and send requests to what they believe is a replica set without changing their connection string or restarting their application.

In Shared Tier, where the Shared Tier is upgraded to MongoDB 8.0, all Shared Tier multi-tenant MongoDBs (MTMs, which may comprise a replica configured to host multiple tenants) may be upgraded to sharded clusters, Atlas Proxy may continue to communicate with MTMs using replica set emulation layer, atlas Proxy may continue to present to customers as a replica set, and shared Tier may present to customers as a sharded cluster for MongoDB 9.0.0, This may not be used where all M0/M2/M5 are migrated to Serverless prior to MongoDB 9.0.0

In Cloud Manager, concurrent with MongoDB 8.0.0, systems may support all new MongoDB 8.0 clusters may be sharded clusters, customers can choose between dedicated and embedded config servers, customer can choose between dedicated and embedded mongos, all existing sharded clusters that are upgraded to MongoDB 8.0 may maintain their current topology on upgrade (e.g. dedicated config servers and dedicated mongos), all existing replica sets that are upgraded to MongoDB 8.0 may become sharded clusters with embedded config servers and embedded mongos, and customers can transition their MongoDB 8.0+sharded clusters to/from dedicated/embedded config servers and dedicated/embedded mongos

For Ops Manager, concurrent Ops Manager systems support the same features as detailed for Cloud Manager.

In some embodiments, Realm may Sync work with 1-shard clusters and may turn on support for sharded clusters. All Atlas Search features may or may not work with 1-shard clusters. Sort beta may be the only feature not provided in sharded clusters and may be provided in other embodiments, or may be backported to 6.0.

Time-Series throughput for 1-shard clusters may be 3× lower than replica sets. Throughput for 1-shard clusters may be 3× lower than replica sets. Reduced throughput may be for sharded clusters with no sharded collections. Systems may have a spike to bolster timeseries performance for 1 shard clusters.

Dev tools may be provided. There may be any new commands that may be used e.g. in the shell to work with the new sharded-by-default setup. Existing commands may work as expected due to the presence of replica set emulation layer. DevTools may bump the driver to make sure systems are using the latest that is optimized for the new sharding behavior. Dev Tools may provide one 8.0 sharded cluster to their e2e tests.

There may be point-in-time backup/restore via the MongoDB tools (mongodump/mongorestore) that work with 1-shard clusters. Where the replica set emulator for sharded clusters allows for reading from the oplog, and there is sufficient behavioral parity between this mode and connecting directly to a replica set shard the functionality may be provided. Where such conditions are not possible, accommodating this feature may use a fundamental re-architecting of mongodump/mongorestore. Cloud may use point-in-time backup/restore using the oplog mode to do backups for shared tier clusters, pausing of m0 clusters, and also for re-balancing shared tier clusters.

Conventional sharding users may need to be product experts in order to appropriately scale. Even then they may run into major issues. Many MongoDB users may have trepidation around adopting sharding for a multitude of reasons such as complexity, lack of feature parity, degraded performance, unpredictable behavior, and difficulty reverting changes. Systems herein provide a sharding product that simply works. The experience may be consistent, performant, predictable, affordable, and without any data loss. Accordingly, systems described herein make sharding invisible to the application and for automatically sharding all MongoDB deployments. According to aspects of the disclosure, unsharded deployments may be completely or substantially eliminated in MongoDB. Systems may not shard for users automatically, without their knowledge or consent, except where the experience is both seamless and pleasant. Sharding users may not even know they're sharded. Aspects of the disclosure relate to serverless systems.

Each MongoDB user (On-prem, Atlas, Serverless) may start out with a sharded deployment. Collections in those clusters may be automatically partitioned as necessary, without work on the part of the cluster owner, and transparently to the application. Data placement and partitioning decisions may be made automatically, and overriding those decisions may be for optimization, not correctness concerns. In some embodiments, 100% of users may have a sharded deployment.

According to some aspects, systems may provide no instances of data loss, corruption, or misplacement, all MongoDB features may be available in sharding, sharding is easy to use, sharding performance may be predictable and invariable (increased spend provides improvement), and/or sharding may have good latency and throughput (getting the best out of current machines).

According to some aspects, sharding may be correct. Sharding may further function with no human effort, thinking, or involvement. For example, sharding may not require the high effort needed with conventional systems for determining the number of shards, choosing a primary shard, migrating chunks, etc. Applications using systems described herein may have to make very few (if any) changes to take advantage the system's sharding capabilities. In some embodiments, sharding may be really fast. A user may see no difference between sharded and unsharded deployments, and between sharded and unsharded collections.

For example, sharded systems herein may provide no data loss, resharding, improved feature parity, acceptable performance, and sharding metrics/stats may be added and exposed to help with shard key recommendation service. Further, sharded systems may provide MQL feature parity, may automatically recommend when to shard a collection(s), may recommend which shard key to use, and may only user intervention is sharding or resharding a collection. Sharded systems may also provide DDL feature parity, all collections may be sharded by default, systems may automatically scale clusters as necessary, and users may not need to worry about what's happening behind the scenes.

Aspects relate to no instances of data loss, corruption, or misplacement. With respect to corruption/loss of stored data, during the movePrimary command, writes to the unsharded database may be lost, data can be lost when removing a shard, Make Migration Commit Protocol Robust to Network Errors and Failovers, movePrimary may not transfer transaction history (moveChunk may), Renaming an unsharded collection across databases may not work where the target database may have a different primary shard, movePrimary may not work where the final index build in the cloned collection takes >60 seconds, new config server primary unlocks all distlocks held by previous config server on step up/general concurrency control around the catalog, and a data loss edge case. The data loss may be silent and has the potential to go unnoticed. This deck and. With respect to data misplacement, UpdateMany may update documents zero times or more than once if there is a concurrent chunk migration (which can surface orphan document updates within change streams)

According to some aspects, MongoDB features are available in sharding. With respect to unsharded collection vs sharded collection, systems may provide MQL (where an application stops working once switched to sharding), may not do updateOne without specifying the shard key, _id duplicate case, $lookup when both collections are sharded, and unique Secondary Indexes without shard key prefix.

With respect to DDL, systems may provide, for renaming a collection, renaming a sharded collection (“dropTarget: true” or false), and renaming an unsharded collection across databases in a sharded cluster, which may be changed in a sharded cluster because the target database may have a different primary shard. In some embodiment, systems may drop a collection completely without user interference, $out to a new sharded collection may not be supported, there may be no syntax to specify how it would be sharded, there may be $out to an existing sharded collection may not be supported, and this may depend on rename sharded drop: true support. There may be atomic DDL operations with consistency guarantees (drop/rename/create), e.g., in some systems there may be a window where a collection has been dropped from some shards but not others, and reads can return partial data. There may be eventually consistent indexes, which may conflict with rolling index builds, and there may be improved UX for Atlas due to no human intervention.

Some aspects relate to differences between unsharded deployment and sharded clusters. For example, Mongos may not have all operational commands that mongod does, giving a mongos URI to an application that used to have a replica set URI may break the app. There may be a validate command, a dbhash command, and a top command. Mongos may treat writeConcern errors as command errors, especially for DDL commands, and some commands may not be idempotent on replica sets but are idempotent in sharding.

In some embodiments, sharding is easy to use (such as by employing intelligent data placement and shard key selection). Ease of use may be provided with a three-pronged approach: (1) being able to reshard, (2) figuring out which shard key to use, and (3) acceptable performance after sharding.

In some embodiments, the server exposes all metrics and stats required such that an external service could implement the shard key selection policy, and may avoid having any hot shards, e.g., no unsharded collections. In some conventional systems, users may be given estimates on when to shard, depending on their workload and the size of their data, while systems herein may look at a user's workload and automatically recommend sharding a collection(s) at the appropriate time (e.g., Shard Key workload analyzer POC). In some embodiments, systems may automatically shard a collection(s) when appropriate. There may be no human/manual intervention needed. In some embodiments recovering from choosing the wrong shard key may be possible and easy. For smaller data sets, unsharding may be provided. For larger data sets, resharding may be required. A “reshardCollection” front end may be implemented as “unshard+shard” as a MVP and supported for small data sets.

In some embodiments, sharding Performance may be predictable and invariable for the same workload. With respect to predictable performance, removing a shard may not stall (, stall due to movePrimary failure, stall due to jumbo chunks) and changing a primary shard may not stall. In some embodiments, if there is a failure, it may be automatically retried, servers may support a mitosis procedure, and mongos may be allowed to retry on snapshot and stale version errors within transactions when possible. In some embodiments, there may be reduced lock scope of migration critical section.

Aspects relate to invariable performance for sharded systems. In some embodiments, routers proactively pull routing table changes from the config servers. Systems may use piggybacking to reduce number of network messages exchanged in the critical section. Systems may also have faster incremental refresh by partitioning routing info cache.

According to some aspects, sharding has good latency and throughput, and may have related performance improvements. In some embodiments, there may be mirror chunk migration across collections, routers may be made to cache view definitions, and there may be cluster-wide writeConcern and readConcern governance. There may be improved usability of shard key updates that include document migration, and all catalog operations within the same database are currently serialized by the config server.

In some embodiments, sharding metadata may not scale well (e.g., because config servers are sometimes the bottleneck), and metadata refresh may take longer than desired. Balancer may be smarter about when to consume resources. Balancing may be another service like shard key selection that may be achieved by something external to the MongoDB cluster if the raw facts and right APIs are exposed and may be pluggable. ReadConcern Majority may have duplicates in sharding. Chunk map scalability may be weak approaching ˜1 M chunks, moves for splits may be slow to ˜1/minute. If chunk map density limits cluster scale on an “envelope edge” systems may not let workloads drive server into WT instability regimes. Shard-draining may hang on Jumbo chunks—may warn/alert user (vs nothing)—or auto-move Jumbos. For example, in some embodiments, Jumbo chunks may no longer be possible and/or all collection data may be redistributed without limitation. There may be an IOPS-based balancer; balancer may also consider dhandles and issue more moves/min. dhandles (e.g., data handles) may represent a named data source, and be used for accessing various data sources of a database system. dhandles management may demand user-managed Zones due to WT limits and balancer may do it.

It should be appreciated that various examples above each describe functions that can be and have been incorporated in different system embodiments together. The examples and described functions are not exclusive and can be used together. Modifications and variations of the discussed embodiments will be apparent to those of ordinary skill in the art and all such modifications and variations are included within the scope of the appended claims.

The terms “program” or “software” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the disclosure provided herein need not reside on a single computer or processor but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Also, various inventive concepts may be embodied as one or more processes, of which examples (e.g., the processes described with reference to figures and functions above, the various system components, analysis algorithms, processing algorithms, etc.) have been provided. The acts performed as part of each process may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, and/or ordinary meanings of the defined terms. As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. A database system comprising one or more database partitions, the database system comprising:
at least one cloud-based resource, the at least one cloud-based resource including processor and memory;
a database subsystem executing on the at least one cloud-based resource, wherein the database subsystem comprises:
a first shard server configured to:
host a first database partition of the one or more database partitions;
manage metadata associated with the one or more database partitions;
route database requests to the first database partition based on the metadata.

2. The database system of claim 1, wherein the database subsystem comprises two or more shard servers, each shard server configured to:
host a respective database partition of the one or more database partitions;
manage metadata associated with the one or more database partitions;
route database requests to the respective database partition based on the metadata.

3. The database system of claim 2, wherein each shard server is configured to run on a same hardware profile for all instance sizes.

4. The database system of claim 1, wherein the database subsystem is configured to:
split the first database partition into the first database partition and a second database partition,
wherein the database subsystem comprises further comprises a second shard server configured to:
host the second database partition;
manage metadata associated with the one or more database partitions;
route database requests to the second database partition based on the metadata.

5. The database system of claim 4, wherein the database subsystem is configured to split the first database partition into the first database partition and the second database partition automatically without user input.

6. The database system of claim 1, wherein, at a first time, the database subsystem comprises a single shard server.

7. The database system of claim 1, wherein the database subsystem is further configured to:
migrate a database from a replica set topology to a sharded topology, the sharded topology including the first database partition hosted by the first shard server.

8. At least one non-transitory computer-readable storage medium having instructions encoded thereon that, when executed by at least one processor, cause the at least one processor to perform a method for hosting a database system comprising one or more database partitions, the method performed using a database system comprising at least one cloud-based resource comprising a database subsystem executing thereon, the method comprising:
using a first shard server of the database subsystem to:
host a first database partition of the one or more database partitions;
manage metadata associated with the one or more database partitions;
route database requests to the first database partition based on the metadata.

9. The at least one non-transitory computer-readable storage medium of claim 8, wherein the database subsystem comprises two or more shard servers and the method further comprises:
using each shard server to:
host a respective database partition of the one or more database partitions;
manage metadata associated with the one or more database partitions;
route database requests to the respective database partition based on the metadata.

10. The at least one non-transitory computer-readable storage medium of claim 9, wherein the method further comprises running each shard server on a same hardware profile for all instance sizes.

11. The at least one non-transitory computer-readable storage medium of claim 8, wherein the method further comprises:
splitting the first database partition into the first database partition and a second database partition,
wherein the database subsystem comprises further comprises a second shard server and the method further comprises using the second shard server to:
host the second database partition;
manage metadata associated with the one or more database partitions;
route database requests to the second database partition based on the metadata.

12. The at least one non-transitory computer-readable storage medium of claim 11, wherein the method comprises splitting the first database partition into the first database partition and the second database partition automatically without user input.

13. The at least one non-transitory computer-readable storage medium of claim 8, wherein, at a first time, the database subsystem comprises a single shard server.

14. The at least one non-transitory computer-readable storage medium of claim 8, wherein the database subsystem is further configured to:
migrate a database from a replica set topology to a sharded topology, the sharded topology including the first database partition hosted by the first shard server.

15. A computer implemented method for hosting a database system comprising one or more database partitions, the method performed using a database system comprising at least one cloud-based resource comprising a database subsystem executing thereon, the method comprising:
using a first shard server of the database subsystem to:
host a first database partition of the one or more database partitions;
manage metadata associated with the one or more database partitions;
route database requests to the first database partition based on the metadata.

16. The method of claim 15, wherein the database subsystem comprises two or more shard servers and the method further comprises:
using each shard server to:
host a respective database partition of the one or more database partitions;
manage metadata associated with the one or more database partitions;
route database requests to the respective database partition based on the metadata.

17. The method of claim 16, wherein the method further comprises running each shard server on a same hardware profile for all instance sizes.

18. The method of claim 15, wherein the method further comprises:
splitting the first database partition into the first database partition and a second database partition,
wherein the database subsystem comprises further comprises a second shard server and the method further comprises using the second shard server to:
host the second database partition;
manage metadata associated with the one or more database partitions;
route database requests to the second database partition based on the metadata.

19. The method of claim 18, wherein the method comprises splitting the first database partition into the first database partition and the second database partition automatically without user input.

20. The method of claim 15, wherein, at a first time, the database subsystem comprises a single shard server.
